(19) United States
(12) Patent Application Publication
(10) Pub. No.: US 2020/0265299 A1
(43) Pub. Date: Aug. 20, 2020

(54) DATA PROCESSING METHOD, DEVICE AND RELATED PRODUCTS

(71) Applicant: Cambricon Technologies Corporation Limited, Beijing (CN)

(72) Inventors: Xunyu CHEN, Beijing (CN); Xiaofu MENG, Beijing (CN)

(21) Appl. No.: 16/714,658

(22) Filed: Dec. 13, 2019

(30) Foreign Application Priority Data
Feb. 18, 2019 (CN) 201910120595.7

(51) Int. Cl. G06N 3/063; G06N 3/08

(52) U.S. Cl. CPC G06N 3/063; G06N 3/08

(57) ABSTRACT

The disclosure relates to a data processing method, a device, and related products. The related product includes a motherboard comprising a CPU and a board card. The board card comprises multiple artificial intelligence processors. Memories corresponding to the artificial intelligence processors are multi-channel. After receiving an artificial intelligence processor computation instruction sent by a general-purpose processor CPU through a target parallel thread, through a memory channel corresponding to the target parallel thread, a target artificial intelligence processor accesses a physical memory corresponding to the memory channel according to the computation instruction. The target artificial intelligence processor is any of the multiple artificial intelligence processors. The target parallel thread is any of multiple parallel threads started by the CPU. At least two threads in the multiple parallel threads correspond to different memory channels. By adopting the method, user-defined activation functions may run smoothly on an artificial intelligence processor.

### TECHNICAL FIELD

The present disclosure relates to the field of artificial intelligence, and in particular relates to a data processing method, device, and related products.

### BACKGROUND

With the development of artificial intelligence technologies, various neural network algorithms have emerged, among which the activation operation is a very important computational step. The existing artificial intelligence processors only support limited types of activation functions which are less than 10 types.

When handling activation functions, the flexibility of the existing artificial intelligence processors is far from satisfactory since they may fail to adjust activation functions for different scenarios.

### SUMMARY

Based on the above-mentioned situation, it is necessary to provide a data processing method, device, and related products to overcome the problem that when handling activation functions, the flexibility of the current neural network processors is far from satisfactory since they may fail to adjust activation functions according to different scenarios.

The present disclosure provides a data processing method including:

obtaining an activation function and a fitting configuration table;

evaluating the fitting configuration table according to the activation function, and generating an evaluation value of the fitting configuration table; and

if the evaluation value of the fitting configuration table does not meet a preset condition, adjusting configuration information to obtain a new fitting configuration table until the evaluation value of the new fitting configuration table meets the preset condition.

In an example, the if the evaluation value of the fitting configuration table does not meet the preset condition, adjusting the configuration information to obtain a new fitting configuration table until the evaluation value of the new fitting configuration table meets the preset condition may include:

obtaining an evaluation value tolerance of the fitting configuration table; and

if the evaluation value of the fitting configuration table does not meet the evaluation value tolerance, adjusting the configuration information to obtain a new fitting configuration table until the evaluation value of the new fitting configuration table meets the evaluation value tolerance.

In an example, the evaluation value tolerance may include a computation quantity tolerance. The if the evaluation value of the fitting configuration table does not meet the preset condition, adjusting the configuration information to obtain a new fitting configuration table until the evaluation value of the new fitting configuration table meets the preset condition may include:

obtaining a computation quantity corresponding to the fitting configuration table according to the fitting configuration table; and

if the computation quantity corresponding to the fitting configuration table is greater than the computation quantity tolerance, adjusting the configuration information to obtain a new fitting configuration table until the computation quantity corresponding to the fitting configuration table is less than or equal to the computation quantity tolerance.

In an example, the evaluation value tolerance of the fitting configuration table may further include an error tolerance. The if the evaluation value of the fitting configuration table does not meet the preset condition, adjusting the configuration information to obtain a new fitting configuration table until the evaluation value of the new fitting configuration table meets the preset condition may further include:

obtaining sampling points of the activation function;

obtaining values of the activation function corresponding to the sampling points and function values corresponding to the fitting configuration table;

obtaining errors of the sampling points according to the values of the activation function corresponding to the sampling points and the function values corresponding to the fitting configuration table; and

if the error of a sampling point is greater than the error tolerance, adjusting the configuration information to obtain a new fitting configuration table until the error of the sampling point is less than or equal to the error tolerance.

In an example, the if the evaluation value of the fitting configuration table does not meet the preset condition, adjusting the configuration information to obtain a new fitting configuration table may include:

comparing the errors of the sampling points to obtain a largest error; and

if the largest error is greater than the error tolerance, adjusting the configuration information to obtain a new fitting configuration table until the largest error is less than or equal to the error tolerance.

In an example, a definition domain of the activation function may include a plurality of piecewise sections, where each piecewise section has a corresponding error tolerance. The if the error of a sampling point is greater than the error tolerance, adjusting the configuration information to obtain a new fitting configuration table until the error of the sampling point is less than or equal to the error tolerance may include:

for each of the piecewise sections, if the error of a sampling point in a piecewise section is greater than a corresponding error tolerance of the piecewise section, marking the piecewise section as a piecewise section to be adjusted, adjusting corresponding configuration information of the piecewise section to be adjusted to obtain a new fitting configuration table of the activation function until the errors of the sampling points of the piecewise section are all less than or equal to the error tolerance corresponding to the piecewise section.

In an example, prior to the obtaining the activation function and the fitting configuration table, the method may further include obtaining the fitting configuration table according to the activation function. The obtaining the fitting configuration table according to the activation function may include:

obtaining the definition domain of the activation function;

determining a count of the piecewise sections of the activation function according to the definition domain;

selecting sampling points in each of the sections according to the count of the piecewise sections of the activation function;

computing a value of the activation function corresponding to each of the sampling points according to the activation function; and

fitting the activation function according to the sampling points and the function values of the sampling points to obtain the fitting configuration table.

In an example, the configuration information may include the count of piecewise sections of the activation function and a count of sampling points in each of the sections;

the if the evaluation value of the fitting configuration table does not meet the preset condition, adjusting the configuration information to obtain a new fitting configuration table until the evaluation value of the new fitting configuration table meets the preset condition may include:

if the evaluation value of the fitting configuration table does not meet the preset condition, adjusting the count of piecewise sections of the activation function, and/or adjusting the count of sampling points in each of the sections; then performing the step of obtaining the fitting configuration table according to the activation function to obtain a new fitting configuration table until the evaluation value of the new fitting configuration table meets the preset condition.

In an example, the adjusting the count of piecewise sections of the activation function, and/or adjusting the count of sampling points in each of the sections may include:

receiving modified configuration information input by an external; and

adjusting the count of piecewise sections of the activation function, and/or adjusting the count of sampling points in each of the sections according to the modified configuration information input by the external.

In an example, the adjusting the count of piecewise sections of the activation function, and/or adjusting the count of sampling points in each of the sections may include:

obtaining a preset condition of an evaluation value of a fitting configuration table of each section; and

automatically adjusting the count of sampling points in each of the sections according to the preset condition of the evaluation value of the fitting configuration table.

In an example, the definition domain of the activation function may include a plurality of piecewise sections. The adjusting the count of piecewise sections of the activation function, and/or adjusting the count of sampling points in each of the sections may include:

determining an adjusting manner of the configuration information according to the evaluation value of the fitting configuration table; and

automatically adjusting the count of piecewise sections of the activation function, and/or adjusting the count of sampling points in each of the sections according to the adjusting manner of the configuration information.

In an example, the if the evaluation value of the fitting configuration table does not meet the preset condition, adjusting the configuration information to obtain a new fitting configuration table until the evaluation value of the new fitting configuration table meets the preset condition may further include:

if the evaluation value of the fitting configuration table does not meet the preset condition, receiving configuration information included in a modified fitting configuration table input by the external; and

adjusting the configuration information of the fitting configuration table according to the configuration information included in the modified fitting configuration table input by the external to obtain a new fitting configuration table until the evaluation value of the new fitting configuration table meets the preset condition.

In an example, the method may further include: outputting and displaying the evaluation value of the fitting configuration table and process parameters of the evaluation, where the process parameters of the evaluation may include one or more of a computation quantity corresponding to the fitting configuration table, an error of a sampling point, a largest error, and a coordinate of a sampling point corresponding to the largest error.

The present disclosure provides a data processing device including:

a data obtaining module configured to obtain an activation function and a fitting configuration table;

an evaluation module configured to evaluate the fitting configuration table according to the activation function, and generate an evaluation value of the fitting configuration table; and

a fitting configuration table adjusting module configured to, if the evaluation value of the fitting configuration table does not meet a preset condition, adjust configuration information to obtain a new fitting configuration table until the evaluation value of the new fitting configuration table meets the preset condition.

The present disclosure provides a board card including a memory and a processor, where a computer program may be stored in the memory, and the processor may implement the steps of any of the methods above when executing the computer program.

The present disclosure provides a motherboard including a general-purpose processor CPU and the board card.

The present disclosure provides an electronic apparatus including the motherboard.

The present disclosure provides a computer readable storage medium. A computer program may be stored in the computer readable storage medium. The computer program may implement the steps of any of the methods above when the computer program is executed by a processor.

The data processing method, the device, and the related products can obtain an evaluation value of a fitting configuration table by evaluating an activation function and the fitting configuration table, then adjust the fitting configuration table according to the relation between the evaluation value and a preset condition, so that the fitting configuration table corresponding to the activation function can be adjusted until it meets the preset condition. In this way, the processing of an activation function can be more flexible.

### BRIEF DESCRIPTION OF THE DRAWINGS

FIG. 1 is a diagram showing an application device of a data processing method according to an example.

FIG. 2 is a flowchart of a method of creating a fitting configuration table according to an example.

FIG. 3 is a flowchart of a data processing method according to an example.

FIG. 4 is a flowchart of adjusting configuration information if an evaluation value of the fitting configuration table does not meet a preset condition according to an example.

FIG. 5 is a flowchart of adjusting the configuration information to obtain the new fitting configuration table according to an example.

FIG. 6 is a flowchart of adjusting the configuration information to obtain the new fitting configuration table according to another example.

FIG. 7 is a flowchart of adjusting the configuration information to obtain the new fitting configuration table according to yet another example.

FIG. 8 is a flowchart of regenerating a fitting configuration table according to an example.

FIG. 9 is a flowchart of an adjusting manner if an evaluation value does not meet a preset condition according to an example.

FIG. 10 is a flowchart of a usage method of configuration information according to an example.

FIG. 11 is a flowchart of performing a fitting operation on the input data according to the configuration information to obtain output data of the activation function according to an example.

FIG. 12 is a diagram showing a data processing device according to an example.

FIG. 13 is a structural diagram of a board card according to an example.

FIG. 14 is a structural diagram of a motherboard according to an example.

### DETAILED DESCRIPTION

In order to make the purposes, technical schemes, and technical effects of the present disclosure clearer, the present disclosure will be described hereinafter with reference to the accompanied drawings and examples. It should be understood that the examples described here are merely used for explaining the present disclosure, rather than limiting the present disclosure.

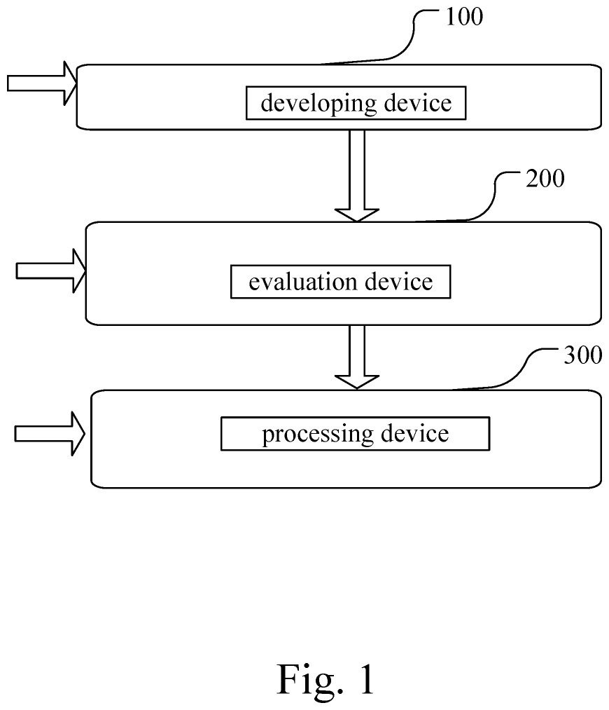

The present disclosure provides a data processing method that can be applied to a data processing device of FIG. 1. The data processing device of FIG. 1 may include a developing device 100, an evaluation device 200, and a processing device 300. Alternatively, the data processing device of the present example may be a heterogeneous processing platform including a general-purpose processing device and a co-processing device. The general-purpose processing device may include the developing device 100 and the evaluation device 200. The co-processing device may be the processing device 300. Alternatively, the general-purpose processing device may be a central processing unit (CPU) and the like. The processing device 300 may be a special-purpose processor such as a neural network processing device. In other examples, the processing device 300 may further be a co-processing device such as GPU or TPU.

The general-purpose processing device is configured to obtain an activation function input by users, and evaluate a fitting configuration table according to the activation function to obtain a new fitting configuration table that meets a preset condition. Specifically, the developing device 100 can obtain an activation function input by users. Alternatively, the activation function may be ReLU, sigmoid, tan h, ReLU1, ReLU6, etc. Furthermore, the developing device 100 is configured to perform piecewise processing on a definition domain of the activation function according to a preset rule to obtain a plurality of piecewise sections, and perform sampling processing (such as using a least square method to perform fitting processing) on the respective piecewise sections to obtain a fitting configuration table corresponding to the activation function.

The evaluation device 200 can evaluate the fitting configuration table according to the activation function to obtain an evaluation value of the fitting configuration table, and when the evaluation value of the fitting configuration table does not meet a preset condition, adjust the fitting configuration table to generate a new fitting configuration table. Alternatively, when the evaluation device 200 determines that the evaluation value of the fitting configuration table does not satisfy the preset condition, the developing device may obtain new configuration information (modified configuration information), and perform piecewise processing, sampling processing, and fitting processing on the activation function again according to the new configuration information to obtain a new fitting configuration table until the new fitting configuration table meets the preset condition.

Alternatively, the evaluation device 200 may output and display an evaluation result of the fitting configuration table. In this way, users can know the evaluation result of the fitting configuration table clearly. Furthermore, when the evaluation device 200 determines that the evaluation value of the fitting configuration table does not meet the preset condition, users can know the evaluation result. Still further, users can modify the configuration information of the activation function manually. The developing device 100 can obtain the new configuration information input by users, and perform piecewise processing, sampling processing, and fitting processing on the activation function according to the new configuration information to obtain the new fitting configuration table until the new fitting configuration table meets the preset condition. In an alternative example, when the evaluation module 200 determines that the fitting configuration table does not meet the preset condition, the evaluation module may send an adjusting signal to the developing device 100. The developing device 100 may automatically adjust the configuration information of the activation function according to the adjusting signal, and obtain the new fitting configuration table according to the new configuration information. Afterwards, the evaluation device 200 may evaluate the new fitting configuration table. The steps above may be performed repeatedly until the new fitting configuration table meets the preset condition.

Alternatively, users may manually modify the configuration information of the fitting configuration table to modify the fitting configuration table directly. In this case, the developing device 100 does not need to repeat a generation process of the fitting configuration table. When users input the configuration information of the fitting configuration table, the evaluation device 200 may modify corresponding parameters of the fitting configuration table directly according to the new configuration information to obtain the new fitting configuration table. Afterwards, the evaluation device 200 may evaluate the new fitting configuration table until the new fitting configuration table meets the preset condition.

In an example of the present disclosure, the configuration information may include starting points and end points of the respective piecewise sections, fitting information corresponding to the respective piecewise sections (including fitting parameters and/or configuration fitting functions), a count of the piecewise sections of the activation function, a count of sampling points of the respective piecewise sections, and the like. The above are merely some instances, and the configuration information may include other possible configuration information.

Alternatively, the evaluation device 200 may determine that when the fitting configuration table meets the preset condition, the developing device 100 can send the fitting configuration table to the processing device 300. Alternatively, the processing device 300 may be a neural network processing device. Furthermore, the processing device 300 may obtain input data of the fitting configuration table of the activation function, and determine fitting information corresponding to the input data in the fitting configuration table (fitting parameters or a configuration fitting function). Still further, the neural network processing device 300 may perform fitting operations on the input data according to the fitting information to obtain output data of the activation function.

Furthermore, the processing device 300 may obtain a function to be configured of the activation function. The processing device 300 may determine the fitting parameters of the respective piecewise sections in the fitting configuration table according to the input data. The processing device 300 may configure the function to be configured to obtain the configuration fitting functions corresponding to the respective piecewise sections according to the fitting parameters. Specifically, the function to be configured refers to a function type that presets a fitting process for an activation function before the fitting operation is performed. For instance, the function to be configured may include: a function of linear equation with one unknown, a function of quadratic equation with one unknown, a proportional function, and an inverse proportional function.

Specifically, the fitting parameters are parameters other than an independent variable and a dependent variable in the function to be configured, and may include a slope and an intercept in a function of linear equation with one unknown. Specifically, each function to be configured corresponds to one function type. One function type may correspond to a plurality of different functions. When fitting parameters are determined, corresponding functions are determined. Taking y=ax as an instance, a fitting parameter a is set to 1, then a corresponding configuration fitting function y=x can be obtained.

As an example, a function to be configured is y=kx+b, a definition domain is [0,16], then a fitting configuration table is as below:

| Starting point of | Ending point of | | |
|---|---|---|---|
| value Xₛₜₐᵣₜ | value X_{end} | k | b |
| 0 | 8 | 1 | 1 |
| 8 | 16 | 2 | 3 |

When 6 is input data, corresponding configuration information can be read:

| | | | |
|---|---|---|---|
| 0 | 8 | 1 | 1 |

According to the configuration information above, output data of the input data 6 is y=1*6+1=7.

Based on the example above, feature parameters or fitting functions of the respective sections can be determined through the fitting configuration table, which can facilitate the quick and easy obtaining of operation results after fitting processing in the execution process of the activation function, thereby improving the operation efficiency.

As another example, a definition domain of an activation function is [0,16]. A sectional fitting function within the range [0, 8) is y=2x+1. A sectional fitting function within the range [8,16] is v=2x²+3x+4. Then a fitting configuration table is as below:

| Starting point of | Ending point of | Fitting |
|---|---|---|
| value Xₛₜₐᵣₜ | value X_{end} | function |
| 0 | 8 | y = 2x + 1 |
| 8 | 16 | y = 2x² + 3x + 4 |

When input data is within [0, 8), output data is computed according to a sectional fitting function y=2x+1. For instance, when input data is 6, the following configuration information can be read:

| | | |
|---|---|---|
| 0 | 8 | y = 2x + 1 |

According to the configuration information above, a corresponding fitting operation is performed on the input data 6, which is y=2*6+1=13. Then output data corresponding to the input data 6 is 13.

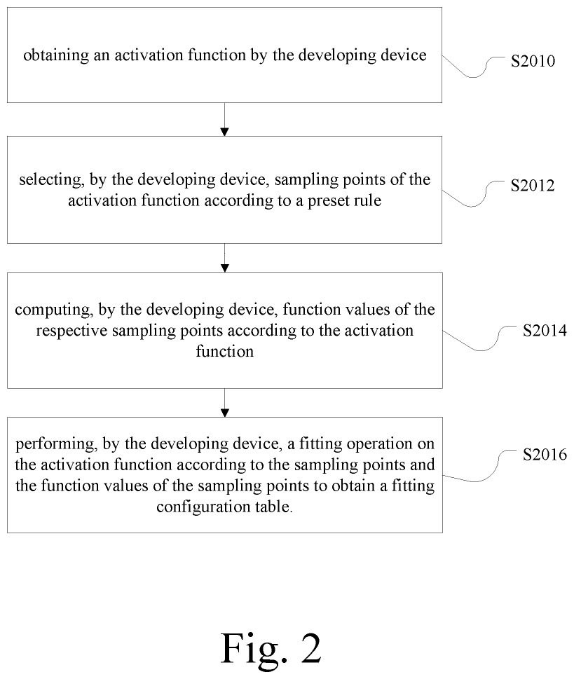

In an example, as shown in FIG. 2, the present disclosure provides a data processing method. An instance in which the method is applied to an application environment as shown in FIG. 1 is provided for explanation. The method may include a process of generating a fitting configuration table as shown by steps S2010 to S23016, in which:

S2010, obtaining an activation function by the developing device 100.

Specifically, each neuron node in a neural network receives an output value of an upper layer of neurons as an input value of a present neuron, and passes the input value to a next layer. The neuron node of the input layer directly passes an input attribute value to the next layer. In a multi-layer neural network, there is a functional relationship between an output of an upper node and an input of a lower node. This function is called an activation function. Alternatively, the activation functions may include ReLU, sigmoid, tan h, ReLU1, and ReLU6. A custom activation function can vary depending on scenarios, such as ReLU5:

$$y = \{ \begin{matrix}- 5 , & x < - 5 \\ x , & - 5 \leq x \leq 5 \\ 5 , & x > 5\end{matrix}$$

Alternatively, the step S2010 may include: obtaining, by the developing device 100, a definition domain of the activation function, and obtaining a count of piecewise sections of the definition domain of the activation function. Specifically, the definition domain of the activation function refers to a range of values of independent variables of the activation function. The count of piecewise sections of the definition domain refers to segmenting the activation function within the definition domain. In an example, the independent variables of the activation function are segmented. It can be understood that the count of sections depends on the shape of the function curve and the accuracy requirement. A minimum of the count is 1, and there is no maximum. Specifically, if a high-precision result is required, or the activation function has a complicated image, the count of sections may be large. For instance, the sigmoid function can be divided into 60 sections. In another example, if the accuracy requirement is not high, or if the activation function has a simple image, the count of sections may be small. For instance, the ReLU function can be divided into two sections. According to the examples above, the activation function is processed in sections so that the whole activation function can be fitted with different functions, which is closer to the original characteristics of the activation function, making the fitting result more accurate.

The method may include the step S2012, selecting, by the developing device 100, sampling points of the activation function according to a preset rule.

The sampling points of the activation function refer to values of independent variables selected in the activation function image according to the preset rule. Specifically, the preset rule of selecting sampling points may be selecting equidistant points, selecting random points, or selecting points according to another rule.

Alternatively, the step S2012 may include: selecting, by the developing device 100, the sampling points in the respective piecewise sections according to the count of sections. Specifically, the count of sections of the definition domain may be a plurality of piecewise sections obtained by segmenting the whole definition domain. Alternatively, sampling within the piecewise sections may be equidistant sampling, such as segmenting each piecewise section into 19 portions of equal size. Alternatively, sampling within the piecewise sections may be inequidistant sampling. Alternatively, the length of each section can be the same, and the count of sampling points in each section can also be the same. Alternatively, the length of each section can be different, and the count of sampling points in each section can also be different. For instance, different piecewise sections may have different precision requirements. A piecewise section with high precision requirement may have more sampling points, and a piecewise section with low precision requirement may have less sampling points.

The method may include the step S2014, computing, by the developing device 100, function values of the respective sampling points according to the activation function. Specifically, the method may include computing to obtain the function values corresponding to the sampling points according to the activation function and values of the independent variables.

The method may include the step S2016, performing, by the developing device 100, a fitting operation on the activation function according to the sampling points and the function values of the sampling points to obtain a fitting configuration table.

An activation function with a complex and capricious image can be fitted into a combination of simple function images by using the fitting operation, which may simplify the computation process of the activation function and improve the computational efficiency. Alternatively, the fitting operation may be realized by using a least square method and/or a quadratic fitting method. The above examples may simplify the process of the activation operation and improve the processing efficiency of the activation function.

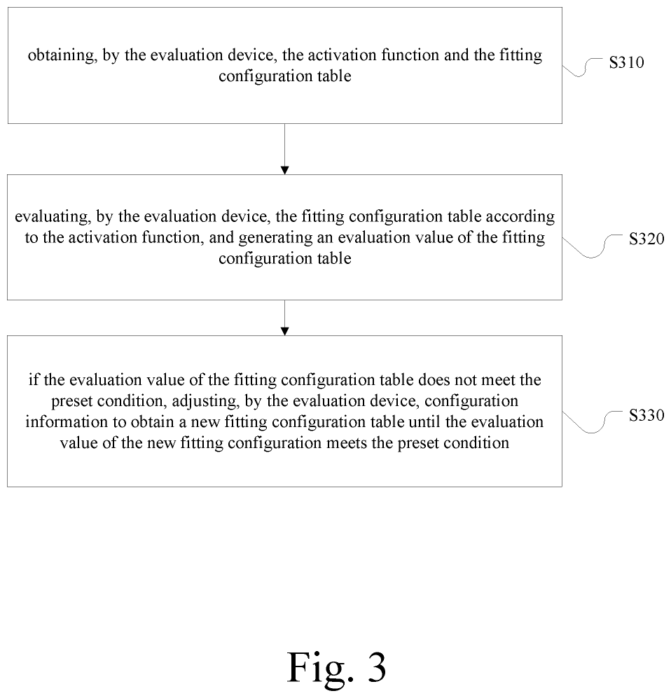

Furthermore and alternatively, referring to FIG. 3, the data processing method of the present disclosure may further include an evaluation process of the fitting configuration table, which are shown in steps S310 to S330 as follows:

the step S310, obtaining, by the evaluation device 200, the activation function and the fitting configuration table.

The fitting configuration table refers to an information table that is referred to for fitting the activation function. A fitting method of the activation function may be determined according to the fitting configuration table. Alternatively, the fitting configuration table may include configuration information corresponding to the activation function.

The method may include the step S320, evaluating, by the evaluation device 200, the fitting configuration table according to the activation function, and generating an evaluation value of the fitting configuration table.

The evaluation value of the fitting configuration table may include evaluation of an attribute of the fitting configuration table, in which the attribute can reflect a difference between the original activation function and a fitting function obtained by performing the fitting operation on the activation function. It can be understood that the smaller the difference between the fitting function corresponding to the fitting configuration table and the original activation function is, the greater the evaluation value of the fitting configuration table is.

The method may include the step S330, if the evaluation value of the fitting configuration table does not meet the preset condition, adjusting, by the evaluation device 200, configuration information to obtain a new fitting configuration table until the evaluation value of the new fitting configuration table meets the preset condition.

The preset condition may be input by the external during the process of evaluating the fitting configuration table, and may also be preset before evaluating the fitting configuration table. Alternatively, the preset condition for different evaluation processes of the fitting configuration table may vary, but the preset condition for one evaluation process is unchanged. Modifications to the configuration information can modify the fitting configuration table directly or indirectly. Alternatively, each preset condition corresponds to an application scenario. When the application scenario is unchanged, the preset condition for different evaluation processes in the same application scenario is also unchanged.

The data processing method, the device, and the related products can obtain the evaluation value of the fitting configuration table by evaluating the activation function and the fitting configuration table, which may make the activation function adjustable, and may improve the flexibility of the processing of the activation function.

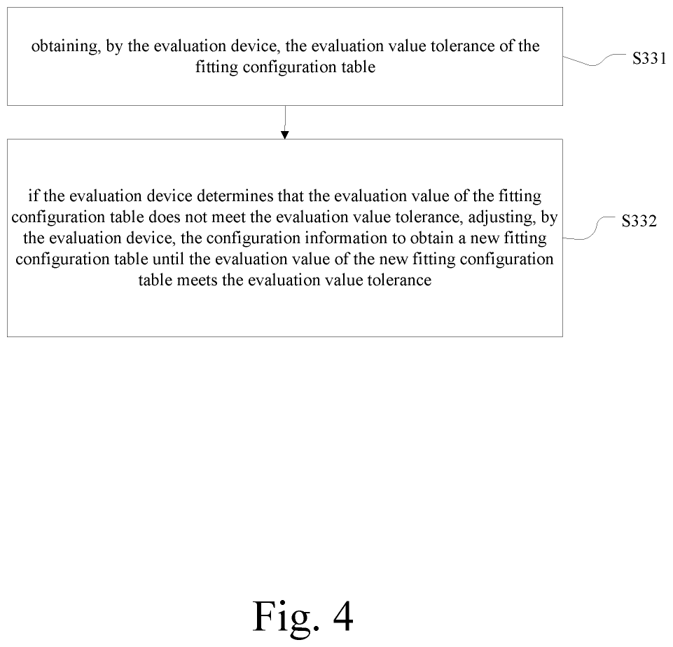

It can be understood that the preset condition may include an evaluation value tolerance. The evaluation value tolerance is for presetting a maximum range of the evaluation value of the fitting configuration table. It can be understood that when the evaluation value of the fitting configuration table is greater than the evaluation value tolerance, the evaluation value of the fitting configuration table does not meet the preset condition. Alternatively, the preset condition may further include other attributes of the fitting configuration table, such as a table length of the fitting configuration table. Specifically, referring to FIG. 4, the step S330 may include:

S331, obtaining, by the evaluation device 200, the evaluation value tolerance of the fitting configuration table. Specifically, the evaluation value tolerance refers to a range requirement for the evaluation value generated from the evaluation. For instance, the evaluation value tolerance is X, then when the evaluation value is greater than X, the evaluation value of the fitting configuration table can be determined as not meeting the evaluation value tolerance. Alternatively, the evaluation value tolerance may be a specific value, and may also be a range.

The method may include the step S332, if the evaluation device 200 determines that the evaluation value of the fitting configuration table does not meet the evaluation value tolerance, adjusting, by the evaluation device, the configuration information to obtain a new fitting configuration table until the evaluation value of the new fitting configuration table meets the evaluation value tolerance.

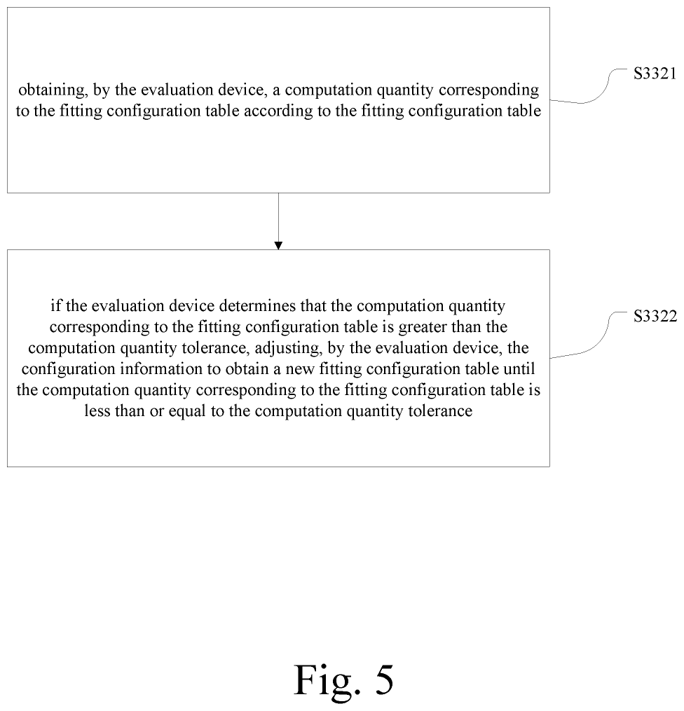

In an example, the evaluation value tolerance may include a computation quantity tolerance and/or an error tolerance. Alternatively, the evaluation device 200 may evaluate whether the fitting configuration table meets the preset condition according to the computation quantity tolerance. Referring to FIG. 5, the step S332 may include:

the step S3321, obtaining, by the evaluation device 200, a computation quantity corresponding to the fitting configuration table according to the fitting configuration table. The computation quantity refers to a count of steps that need to be performed in the process of computing input data to obtain output data. It can be understood that, if the computation quantity is large, the input data needs to be subject to more steps, in which computations are cumbersome, the time is long, and the energy consumption is large; when the computation quantity is small, the input data needs to be subject to few steps, in which computations are simple, and the time is short. In this case, when the computation quantity is large, a computation result may have better precision compared with that of the small computation quantity.

Specifically, after the fitting configuration table is generated, the developing device 100 may send the fitting configuration table that meets the preset condition to the processing device 300. The processing device 300 can perform an activation operation according to the fitting configuration table. The computation quantity of the fitting configuration table is a computation quantity of the processing device 300 when the processing device 300 performs the activation operation according to the fitting configuration table (for instance, the computation quantity can be expressed by computation time. The longer the computation time is, the larger the computation quantity is). In this case, when the fitting configuration table is generated, the computation quantity corresponding to the fitting configuration table is determined. It can be understood that different fitting configuration tables correspond to different computation quantities.

The method may include a step S3322, if the evaluation device 200 determines that the computation quantity corresponding to the fitting configuration table is greater than the computation quantity tolerance, adjusting, by the evaluation device 200, the configuration information to obtain a new fitting configuration table until the computation quantity corresponding to the fitting configuration table is less than or equal to the computation quantity tolerance. The computation quantity tolerance refers to a maximum value of the computation quantity that can be tolerated.

Specifically, simplifying the computation process of the activation function at the cost of precision loss in a neural network operation can greatly improve the computation efficiency and ensure the computation result is valid. When the computation quantity is greater than the computation quantity tolerance, the computation process cannot be simplified significantly, which cannot realize the expected improvement of the computational efficiency. In this case, the fitting configuration table needs to be adjusted for obtaining a new fitting configuration table that meets the requirements for computational efficiency.

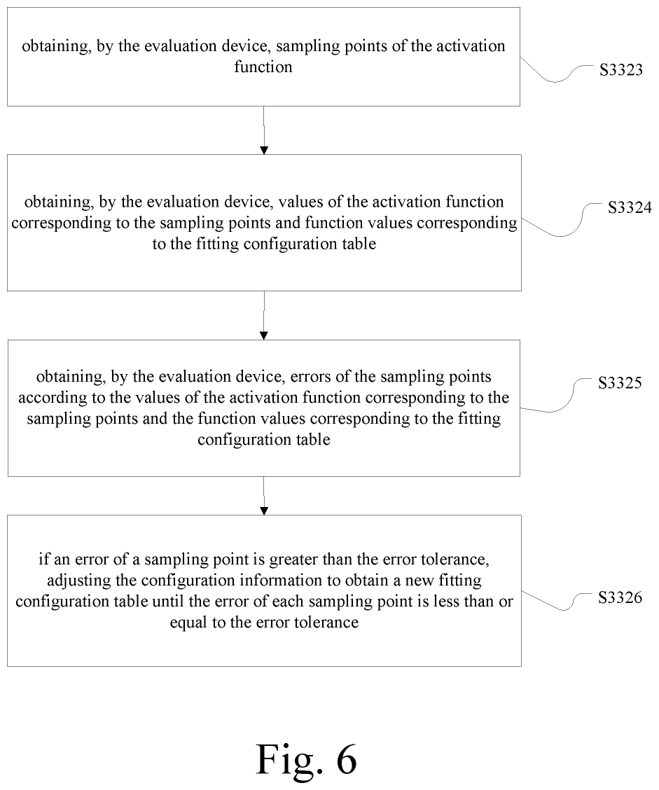

Alternatively, the evaluation device 200 may evaluate whether the fitting configuration table meets the preset condition according to the error tolerance. Referring to FIG. 6, the step S332 may further include:

a step S3323, obtaining, by the evaluation device 200, sampling points of the activation function. The sampling points refer to values selected in the definition domain of the activation function according to a preset rule. Specifically, the preset rule of selecting sampling points may be selecting equidistant points, selecting random points, or selecting points according to another rule. In the present disclosure, the sampling points may be sampling points obtained by the developing device 100 when the developing device 100 obtains the fitting configuration table.

The method may include a step S3324, obtaining, by the evaluation device 200, values of the activation function corresponding to the sampling points and function values corresponding to the fitting configuration table. Specifically, each sampling point is a value point of input data in the definition domain of the activation function. The value of the sampling point is used as input data to obtain a function value of the activation function at the sampling point. In an example, the fitting configuration table can be determined according to the sampling points, then a corresponding computation process of the sampling points can be determined. The corresponding computation process can be performed with the sampling points as input data to obtain corresponding function values of the fitting configuration table.

The method may include a step S3325, obtaining, by the evaluation device 200, errors of the sampling points according to the values of the activation function corresponding to the sampling points and the function values corresponding to the fitting configuration table. The errors refer to the amount of precision sacrificed by the fitting configuration table which is obtained by fitting, compared with the activation function without fitting. Specifically, for each sampling point, the operation of the activation function and the operation corresponding to the fitting configuration table are respectively performed with the value of the sampling point as the input data, and the value of the activation function and the function value corresponding to the fitting configuration table are obtained respectively. Therefore, for the same input data, a difference between the corresponding function value of the fitting configuration table and the value of the activation function represents the error of each sampling point. Alternatively, for each sampling point, the above-mentioned error may be obtained by computing a difference between the value of the activation function and the function value corresponding to the fitting configuration table. Alternatively, for each sampling point, the above-mentioned error may be obtained by computing a variance of the value of the activation function and the function value corresponding to the fitting configuration table.

The method may include a step S3326, if the error of the sampling point is greater than the error tolerance, adjusting the configuration information to obtain a new fitting configuration table until the error of each sampling point is less than or equal to the error tolerance.

The error tolerance refers to a maximum value of error that can be tolerated. If the error exceeds the error tolerance, the difference between the output result obtained from the fitting configuration table and the output result of the original activation function is too large. In this case, the output result obtained from the fitting configuration table is invalid. In this example, when the error of each sampling point in the definition domain is smaller than the error tolerance, it is determined that the error meets the requirement of the error tolerance.

Alternatively, the process of evaluating the fitting configuration table by the activation function may be performed solely according to the computation quantity (as shown in FIG. 5), may also be performed solely according to the error (as shown in FIG. 6), and may further be performed according to the computation quantity and the error. When the evaluation is performed according to the computation quantity and the error, a balance between the error and the computation quantity during a computation process may be achieved, thereby realizing a best computational efficiency. For instance, when the computation quantity exceeds a threshold or the error exceeds a threshold, it can be determined that an evaluation result does not meet the preset condition. For another instance, when the computation quantity exceeds a threshold and the error exceeds a threshold, it can be determined that an evaluation result does not meet the preset condition.

Alternatively, in another example, the step S332 may include: obtaining a midpoint of every two sampling points of the activation function; obtaining a value of the activation function of each midpoint and a function value of the fitting configuration table; obtaining an error of each midpoint according to the value of the activation function of the midpoint and the function value of the fitting configuration table; and if the error of the midpoint is greater than the error tolerance, adjusting the configuration information to obtain a new fitting configuration table until the error of the midpoint is less than or equal to the error tolerance. Alternatively, the method may include: when computing the error between the fitting configuration table and the activation function, selecting equidistant coordinates or selecting random coordinates in the definition domain of the activation function to compute the function value corresponding to the fitting configuration table and the function value corresponding to the activation function. In this way, the error of the function value corresponding to the fitting configuration table and the function value corresponding to the activation function can be reflected.

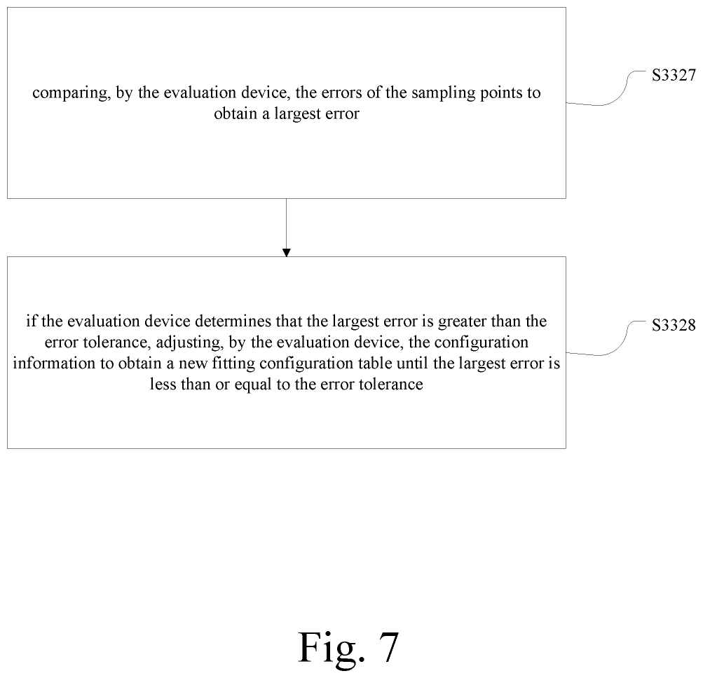

Furthermore, to improve the computational efficiency of the evaluation process of the fitting configuration table, the largest error corresponding to each sampling points of the definition domain can be obtained. Specifically, referring to FIG. 7, the step S3326 may include:

a step S3327, comparing, by the evaluation device 200, the errors of the sampling points to obtain a largest error. The largest error refers to a largest error among the errors of the sampling points. Alternatively, the step S3327 may further include sorting the errors of the sampling points to obtain the largest error.

Further, after the largest error is obtained, the method may further include determining a position of the largest error. For instance, the method may include obtaining a coordinate of a sampling point corresponding to the largest error. With the largest error and the coordinate of the sampling point corresponding to the largest error, when feeding back the fitting configuration table, an adjusting strategy of the fitting configuration table may be fed back, so that the adjusted fitting configuration table can meet the requirement of the evaluation value tolerance.

The method may include a step S3328, if the evaluation device 200 determines that the largest error is greater than the error tolerance, adjusting, by the evaluation device 200, the configuration information to obtain a new fitting configuration table until the largest error is less than or equal to the error tolerance. In this example, as long as the largest error is less than or equal to the error tolerance, it can be determined that the error meets the requirement of the error tolerance.

According to the steps of the present example, when determining whether configuration information meets the requirement of the error tolerance, it is only needed to determine whether the largest error meets the requirement of the error tolerance, and there is no need to determine for each sampling point, which may reduce the computation quantity and improve the evaluation efficiency.

Further and alternatively, the count of the piecewise sections of the activation function refer to a count of piecewise sections of the definition domain of the activation function. The count of the piecewise sections of the definition domain may be a plurality of sectional ranges obtained by dividing the definition domain, so that the definition domain of the activation function may include a plurality of piecewise sections. An error tolerance may be set for each of the piecewise sections correspondingly. The step S3328 may further include:

for each of the piecewise sections, if the error of a sampling point in a piecewise section is greater than a corresponding error tolerance of the piecewise section, marking the piecewise section as a piecewise section to be adjusted, adjusting corresponding configuration information of the piecewise section to be adjusted to obtain a new fitting configuration table of the activation function until the errors of the sampling points of the piecewise section are all less than or equal to the error tolerance corresponding to the piecewise section. Further, the evaluation device 200 may obtain the largest error of each sampling point in each piecewise section by computing, and when the largest error of a sampling point in a piecewise section is greater than the error tolerance of the piecewise section, marking the piecewise section as a piecewise section to be adjusted, adjusting corresponding configuration information of the piecewise section to be adjusted to obtain a new fitting configuration table of the activation function until the errors of the sampling points of the piecewise section are all less than or equal to the error tolerance corresponding to the piecewise section.

Specifically, the error tolerances of the respective piecewise sections may be the same, or may all be different. When it is detected that there is a sampling point in a piecewise section whose error is greater than the error tolerance of the piecewise section, the piecewise section is marked as a piecewise section to be adjusted. Alternatively, the error tolerance of each section may be determined according to the importance of the section for a whole result. It can be understood that the error tolerance of an important section is less than the error tolerance of a less important section. In this way, by merely adjusting the configuration information of the section to be adjusted, the efficiency of the adjusting may be improved, and the efficiency of generating a new fitting configuration table may also be improved. In an example, the configuration information may include the count of the piecewise sections of the activation function and a count of the sampling points in each of the sections. The step S330 may include:

if the evaluation value of the fitting configuration table does not meet the preset condition, adjusting the count of piecewise sections of the activation function, and/or adjusting the count of sampling points in each of the sections; then performing the step of obtaining the fitting configuration table according to the activation function to obtain a new fitting configuration table until the evaluation value of the new fitting configuration table meets the preset condition.

Alternatively, when the evaluation device 200 determines that the evaluation value of the fitting configuration table does not meet the preset condition, the developing device 100 may adjust the count of piecewise sections of the activation function, and/or adjust the count of sampling points in each of the sections, obtain modified configuration information, afterwards, the developing device may obtain a new fitting configuration table according to the modified configuration information until the evaluation device determines an evaluation value of the new fitting configuration table meets the preset condition. Alternatively, if there is a sampling point whose error is greater than the error tolerance, the method may include increasing the count of the piecewise sections of the activation function, and/or increasing the count of the sampling points in each section. Alternatively, if the largest error is greater than the error tolerance, the method may include increasing the count of the piecewise sections of the activation function, and/or increasing the count of the sampling points in each section. Alternatively, if the corresponding computation quantity of the fitting configuration table is greater than the computation quantity tolerance, the method may include decreasing the count of the piecewise sections of the activation function, and/or decreasing the count of the sampling points in each section. Alternatively, a process of “the adjusting the count of piecewise sections of the activation function, and/or adjusting the count of sampling points in each of the sections” in the step S330 may be adjusted automatically. Specifically, the step above may include:

determining, by the developing device 100, an adjusting manner of the configuration information according to the evaluation value of the fitting configuration table; and automatically adjusting, by the developing device 100, the count of piecewise sections of the activation function, and/or adjusting the count of sampling points in each of the sections according to the adjusting manner of the configuration information.

Specifically, when the evaluation device 200 determines that the evaluation value of the fitting configuration table does not meet the preset condition, the evaluation device 200 may send an adjusting signal to the developing device (the adjusting signal may carry the evaluation value of the current fitting configuration table). The developing device 100 may determine an adjusting manner of the configuration information according to the evaluation value of the fitting configuration table and an automatic adjusting strategy stored in a memory. Then the developing device 100 may automatically adjust the count of piecewise sections of the activation function, and/or adjust the count of sampling points in each of the sections according to the adjusting manner of the configuration information. The automatic adjusting strategy may be obtained by the developing device according to the evaluation value of the fitting configuration table. For instance, the developing device 100 may obtain a corresponding error tolerance of each piecewise section, and automatically adjust the section whose error is greater than the error tolerance according to the error tolerance of each piecewise section in the fitting configuration table. For instance, if the error of a sampling point in the piecewise section is greater than the error tolerance, the count of sampling points in the piecewise section may be increased. Furthermore, if the largest error is greater than the error tolerance, the count of sampling points in the piecewise section may be increased.

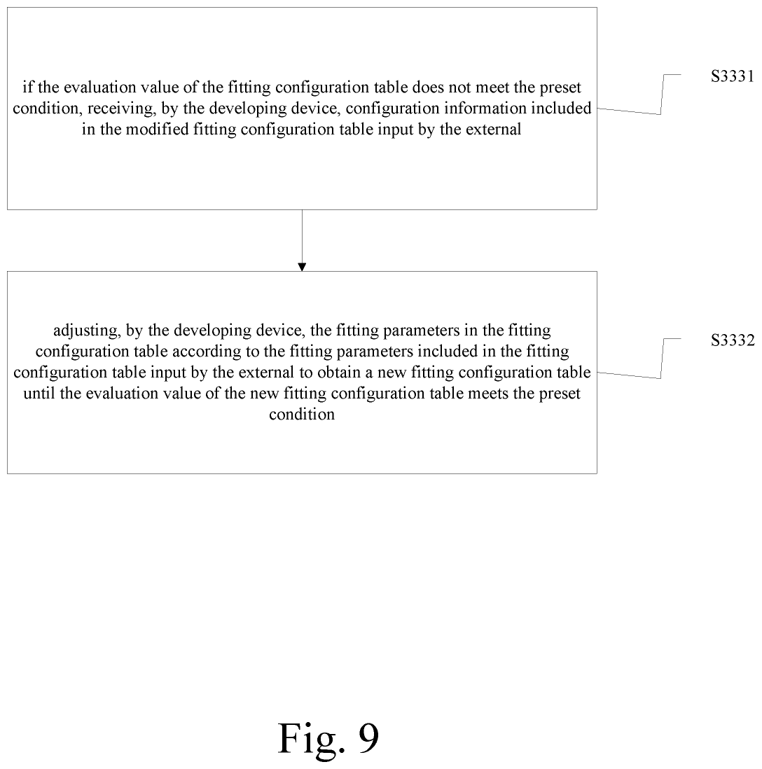

Alternatively, users may manually modify the configuration information according to an evaluation result to obtain a new fitting configuration table. For instance, users may manually modify the count of the piecewise sections of the activation function, and or the count of the sampling points, and the like. For another instance, users may manually modify parameters in the configuration information. Alternatively, referring to FIG. 9, when the evaluation value of the fitting configuration table does not meet the preset condition, the adjusting the count of piecewise sections of the activation function, and/or adjusting the count of sampling points in each of the sections may include:

a step S3331, receiving, by the developing device 100, modified configuration information input by the external, where the external refers to the external of the developing device 100. Specifically, the modified configuration information refers to a set of parameters for generating a new fitting configuration table. Correspondingly, the modified new configuration information may include a modified count of piecewise sections in the activation function, and/or a target adjustment of a modified count of sampling points of each section.

The method may include a step S3332, adjusting, by the developing device 100, the count of piecewise sections of the activation function, and/or adjusting the count of sampling points in each of the sections according to the modified configuration information input by the external. Specifically, the modified configuration information may include the count of the piecewise sections of the activation function, and/or the target adjustment of the count of sampling points in each of the sections.

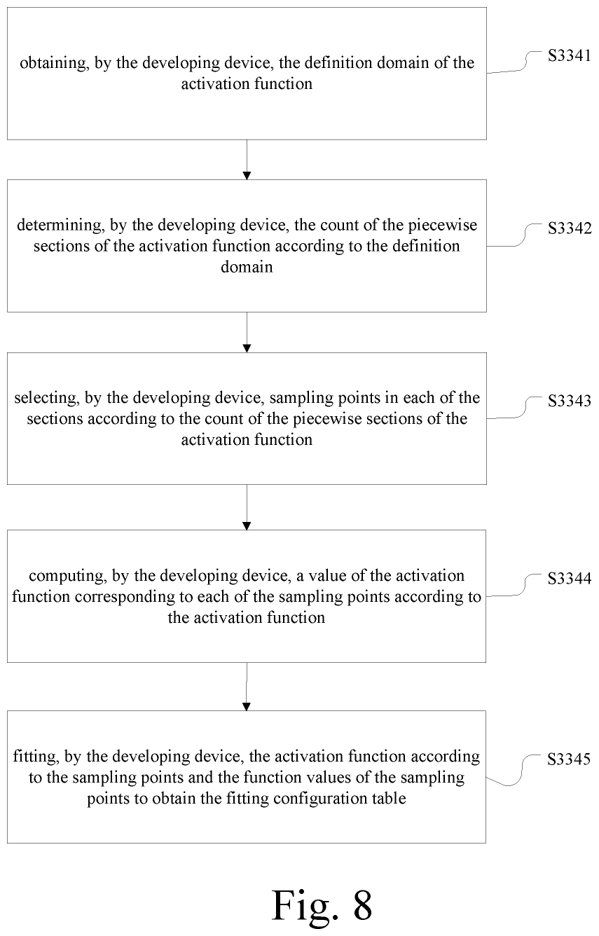

Specifically, the developing device 100 may receive the modified configuration information input by the external. The configuration information may be subject to piecewise processing and sampling processing in the developing device 100 for obtaining a new fitting configuration table. Specifically, as shown in FIG. 8, after the developing device obtains the modified configuration information, the following step may be performed: S3341, obtaining, by the developing device 100, the definition domain of the activation function; S3342, determining, by the developing device 100, the count of the piecewise sections of the activation function according to the definition domain; S3343, selecting, by the developing device 100, sampling points in each of the sections according to the count of the piecewise sections of the activation function; S3344, computing, by the developing device 100, a value of the activation function corresponding to each of the sampling points according to the activation function; and S3345, fitting, by the developing device 100, the activation function according to the sampling points and the function values of the sampling points to obtain the fitting configuration table. A specific description of the steps S3341 to S3345 is similar to the description of the steps S2010 to S2016 in the preceding part, and is thus omitted here.

Furthermore, the new fitting configuration table may be output to the evaluation device 200 for evaluation. If the new fitting configuration table meets the preset condition, the evaluation device 200 may output the new fitting configuration table to the processing device 300 for an activation operation. Alternatively, the evaluation device 200 may also receive the new configuration information in the fitting configuration table directly, replace the original configuration information in the fitting configuration table with the new configuration information. In this way, the fitting configuration table is updated, and the new fitting configuration table is obtained. The evaluation device 200 may evaluate the new fitting configuration table again. If the new fitting configuration table meets the preset condition, the evaluation device 200 may output the new fitting configuration table to the processing device 300. Specifically, the “when the evaluation value of the fitting configuration table does not meet the preset condition, adjusting the count of piecewise sections of the activation function, and/or adjusting the count of sampling points in each of the sections” in the step S330 may include:

if the evaluation value of the fitting configuration table does not meet the preset condition, receiving, by the evaluation device 200, the configuration information included in the modified fitting configuration table input by the external. Specifically, by directly receiving the configuration information included in the modified fitting configuration table input by the external, the fitting configuration table can be modified directly. The evaluation device 200 may adjust the configuration information of the fitting configuration table according to the configuration information included in the modified fitting configuration table input by the external, so as to obtain a new fitting configuration table until the evaluation value of the new fitting configuration table meets the preset condition.

In an example, the data processing method may further include: outputting and displaying the evaluation value of the fitting configuration table and process parameters of the evaluation, where the process parameters of the evaluation may include one or more of a computation quantity corresponding to the fitting configuration table, an error of a sampling point, a largest error, and a coordinate of a sampling point corresponding to the largest error. As an example, the evaluation value of the fitting configuration table and the process parameters of the evaluation may be output in a form of visual information. Specifically, the evaluation value of the fitting configuration table and the process parameters of the evaluation may be output in a form of a curve graph or diagram, and may be displayed on a display device. By outputting the evaluation value of the fitting configuration table and the process parameters of the evaluation in the form of visual information and displaying them, users can know the fitting process of the fitting configuration table and the degree of difference from the preset condition. In this way, the method may provide guidance and enlightenment for users to further adjust the fitting configuration table.

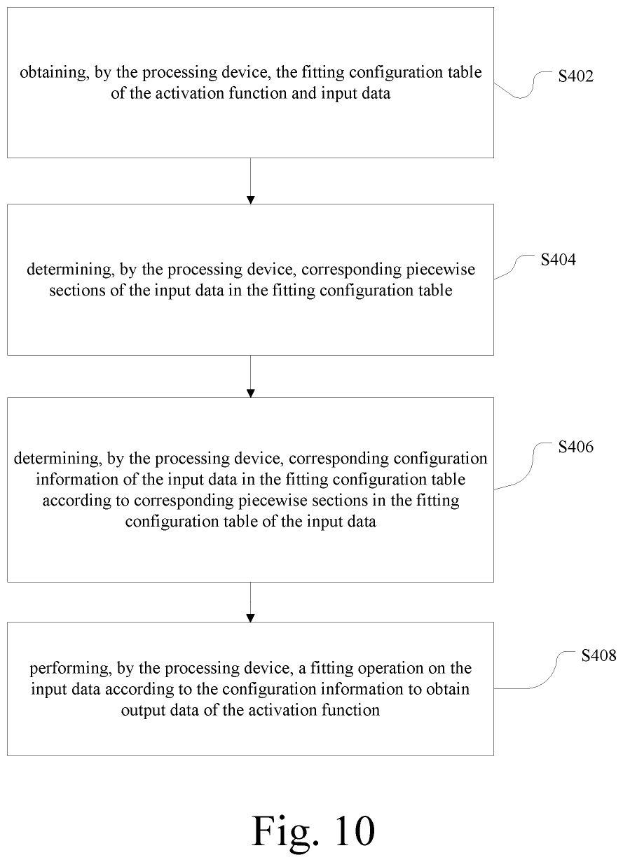

As a further improvement, the fitting configuration table that meets the preset condition may be used for implementing an activation operation. In other words, the developing device 100 may input the fitting configuration table that meets the preset condition into the processing device 300. The processing device 300 may receive the fitting configuration table input by the developing device 100 as well as input data input by users, then perform the activation operation according to the input data and the fitting configuration table to obtain output data of the activation operation. Specifically, referring to FIG. 10, the method may further include:

a step S402, obtaining, by the processing device 300, input data. Specifically, the step S402 may further include obtaining the fitting configuration table of the activation function. The fitting configuration table is a fitting configuration table that is evaluated by the evaluation device 200 as meeting the preset condition. A fitting method of the activation function may be determined according to the fitting configuration table. The input data refers to data for the computation of the activation function.

The method may include a step S404, determining, by the processing device 300, corresponding piecewise sections of the input data in the fitting configuration table. The fitting configuration table may have a plurality of continuous piecewise sections. The piecewise sections form the definition domain of the activation function. It can be understood that the input data is data within the definition domain, and the input data corresponds to the piecewise sections in the fitting configuration table. The definition domain refers to a range of values of independent variables of the activation function.

Alternatively, the step S404 may include, determining, by the processing device 300, sectional fitting functions of the respective piecewise sections according to the input data. Specifically, the sectional fitting functions refer to fitting functions corresponding to the respective piecewise sections, which means one piecewise section may correspond to a sectional fitting function. Alternatively, the sectional fitting functions may all be different, or may be the same, or may be partially the same and partially different.

The method may include a step S406, determining, by the processing device 300, corresponding configuration information of the input data in the fitting configuration table according to corresponding piecewise sections in the fitting configuration table of the input data.

The method may include a step S408, performing, by the processing device 300, a fitting operation on the input data according to the configuration information to obtain output data of the activation function. Specifically, the process of processing the input data by the processing device 300 according to the configuration information is a process of fitting the activation function to obtain the output data of the fitting function.

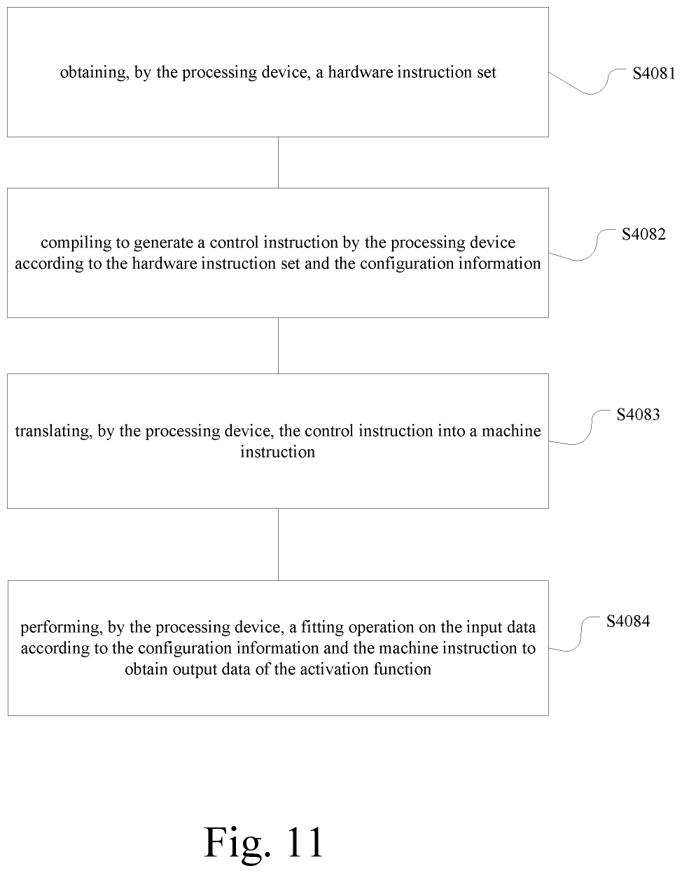

Further, referring to FIG. 11, the step S408 may include:

a step S4081, obtaining, by the processing device 300, a hardware instruction set. The hardware instruction set refers to a basic instruction format of hardware apparatus. In an example, the hardware instruction set refers to a basic instruction format that can apply to an artificial intelligence processor. The hardware instruction set may be an instruction set obtained from compiling. The compiling may be performed by a general-purpose processor.

The method may include a step S4082, decoding to generate a control instruction by the processing device 300 according to the hardware instruction set and the configuration information. Specifically, the configuration information included in the fitting configuration table generated by the neural network developing device 100 may be sent to the neural network processing device 300 after the configuration information is evaluated. The neural network processing device 300 cannot read the configuration information directly. For the reason, the neural network processing device 300 or the neural network developing device 100 may generate a control instruction corresponding to the configuration information according to a basic instruction generated by the neural network processing device 300.

The method may include a step S4083, translating, by the processing device 300, the control instruction into a machine instruction. Specifically, the control instruction generated in the step S4082 cannot be recognized by a machine after the control instruction is transferred to the neural network processing device 300. Furthermore, the neural network processing device 300 may compile the control instruction to translate the control instruction into the machine instruction that can be recognized by the neural network processing device 300 directly. In an example, the machine instruction is a binary instruction.

The method may include a step S4084, performing, by the processing device 300, a fitting operation on the input data according to the configuration information and the machine instruction to obtain output data of the activation function. Specifically, by recognizing the machine instruction, the neural network processing device 300 may read the fitting configuration table according to the input data, and obtain the configuration information corresponding to the input data in the fitting configuration table. Furthermore, the input data may be processed according to the configuration information. The neural network processing device 300 may be controlled according to the machine instruction to obtain output data of the activation function.

It should be understood that though respective steps in the flowcharts FIGS. 2-11 are shown following the direction of arrows, yet these steps may not necessarily be performed following the order indicated by the arrows. Unless clearly stated herein, the order for performing these steps is not strictly confined. These steps may be performed in a different order. Additionally, at least part of the steps shown in FIGS. 2-11 may include a plurality of sub-steps or a plurality of phases. These sub-steps or phases may not necessarily be performed and completed at the same time, instead, these sub-steps or phases may be performed at different time. These sub-steps or phases may not necessarily be performed sequentially either, instead, these sub-steps or phases may be performed in turn or alternately with at least part of other steps, or sub-steps of other steps, or phases.

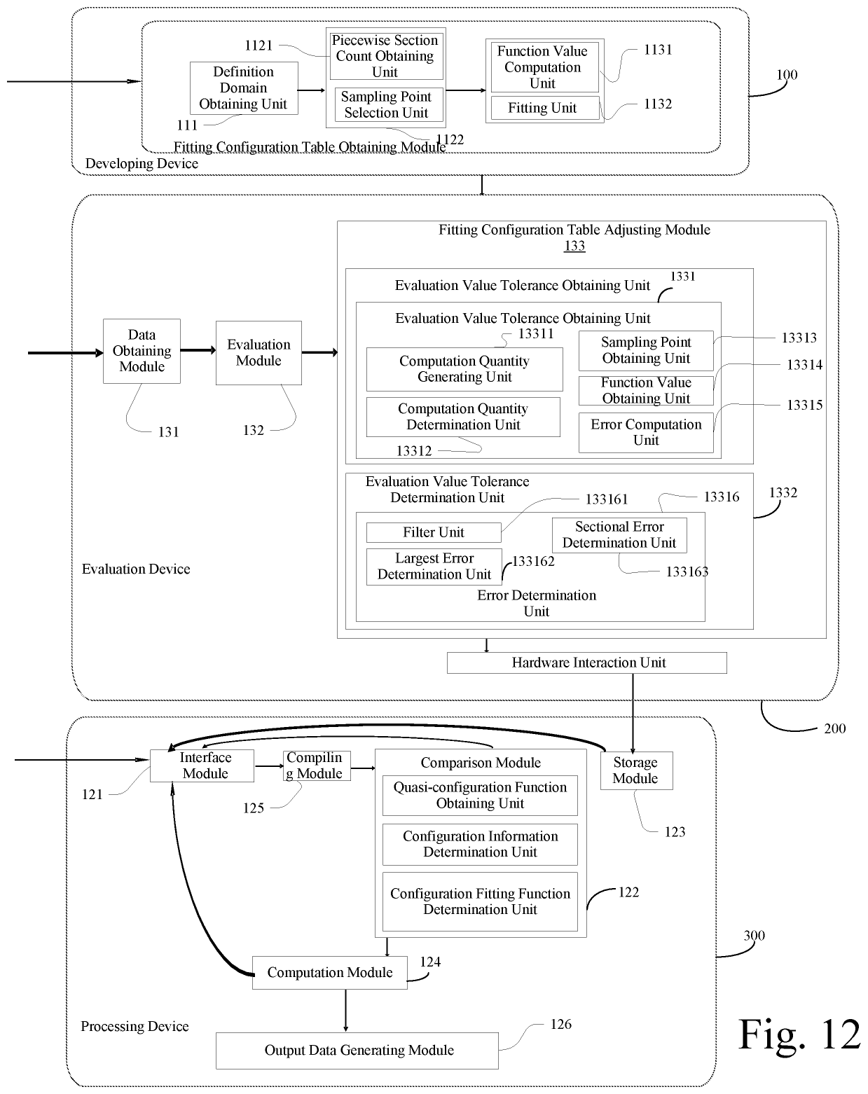

In an example, referring to FIG. 12, the present disclosure provides a data processing device which may include a developing device 100, an evaluation device 200, and a processing device 300. Alternatively, the data processing device of the present example may be a heterogeneous processing platform including a general-purpose processing device and a co-processing device. The general-purpose processing device may include the developing device 100 and the evaluation device 200. The co-processing device may be the processing device 300. Alternatively, the general-purpose processing device may be a central processing unit (CPU) and the like. The processing device 300 may be a special-purpose processor such as a neural network processing device.

The developing device may be implemented in a form of a hardware device or in a combination of hardware and software. The developing device 100 may include a fitting configuration table obtaining module which may include: a definition domain obtaining unit 111, a piecewise section count obtaining unit 1121, a sampling point selection unit 1122, a function value computation unit 1131, and a fitting unit 1132. The definition domain obtaining unit 111 is configured to obtain an activation function. The piecewise section count obtaining unit 1121 is configured to determine a count of piecewise sections of the activation function. The sampling point selection unit 1122 is configured to select sampling points in each of the sections according to the count of the piecewise sections of the activation function. The sampling point selection unit 1122 is configured to obtain sampling points in each of the sections according to the count of the piecewise sections of the activation function. The function value computation unit 1131 is configured to compute a value of the activation function corresponding to each of the sampling points according to the activation function. The fitting unit 1132 is configured to fit the activation function according to the sampling points and the function values of the sampling points to obtain a fitting configuration table.

Alternatively, the evaluation device 200 may include a data obtaining module 131, an evaluation module 132, and a fitting configuration table adjusting module 133. The data obtaining module 131 is configured to obtain the activation function and the fitting configuration table. The evaluation module 132 is configured to evaluate the fitting configuration table according to the activation function, and generate an evaluation value of the fitting configuration table. The fitting configuration table adjusting module 133 is configured to, if the evaluation value of the fitting configuration table does not meet a preset condition, adjust configuration information to obtain a new fitting configuration table until the evaluation value of the new fitting configuration table meets the preset condition.

Alternatively, the fitting configuration table adjusting module 133 may include an evaluation value tolerance obtaining unit 1331, and an evaluation value tolerance determination unit 1332. The evaluation value tolerance obtaining unit 1331 is configured to obtain an evaluation value tolerance of the fitting configuration table. The evaluation value tolerance determination unit 1332 is configured to, if the evaluation value of the fitting configuration table does not meet the evaluation value tolerance, adjust the configuration information to obtain a new fitting configuration table until the evaluation value of the new fitting configuration table meets the evaluation value tolerance.

Alternatively, the evaluation value tolerance of the fitting configuration table may include a computation quantity tolerance. The evaluation value tolerance obtaining unit 1331 may include a computation quantity generating unit 13311 which is configured to obtain a computation quantity corresponding to the fitting configuration table according to the fitting configuration table. The evaluation value tolerance obtaining unit 1331 may include a computation quantity determination unit 13312 configured to, if the computation quantity corresponding to the fitting configuration table is greater than the computation quantity tolerance, adjust the configuration information to obtain a new fitting configuration table until the computation quantity corresponding to the fitting configuration table is less than or equal to the computation quantity tolerance.

Alternatively, the tolerance value tolerance of the fitting configuration table may include an error tolerance. The evaluation value tolerance obtaining unit 1331 may further include a sampling point obtaining unit 13313, a function value obtaining unit 13314, and an error computation unit 13315. The sampling point obtaining unit 13313 is configured to obtain the respective sampling points of the activation function. The function value obtaining unit 13314 is configured to obtain a function value of the activation function corresponding to each of the sampling points and a function value corresponding to the fitting configuration table. The error computation unit 13315 is configured to obtain the error of each of the sampling points according to the function value of the activation function corresponding to each of the sampling points and the function value corresponding to the fitting configuration table. The evaluation value tolerance determination unit may further include an error determination unit 13316 configured to, if the error of a sampling point is greater than the error tolerance, adjust the configuration information to obtain a new fitting configuration table until the error of the sampling point is less than or equal to the error tolerance.

Furthermore, the error determination unit 13316 may include a filter unit 133161 and a largest error determination unit 133162. The filter unit 133161 is configured to compare errors of the sampling points to obtain a largest error. The largest error determination unit 133162 is configured to, if the largest error is greater than the error tolerance, adjust the configuration information to obtain a new fitting configuration table until the largest error is less than or equal to the error tolerance.

Furthermore, the error determination unit 13316 may further include a sectional error determination unit 133163 configured to, for each of the piecewise sections, if the error of a sampling point in a piecewise section is greater than a corresponding error tolerance of the piecewise section, mark the piecewise section as a piecewise section to be adjusted, adjust corresponding configuration information of the piecewise section to be adjusted to obtain a new fitting configuration table of the activation function until the errors of the sampling points of the piecewise section are all less than or equal to the error tolerance corresponding to the piecewise section.

Alternatively, the configuration information may include the count of the piecewise sections and a count of sampling points in each of the sections. The fitting configuration table adjusting module 133 is further configured to: if the evaluation value of the fitting configuration table does not meet the preset condition, adjust the count of piecewise sections of the activation function, and/or adjust the count of sampling points in each of the sections, then call the fitting configuration table obtaining module to obtain the fitting configuration table.

Alternatively, the data processing device may further include a developing device 100 configured to:

receive modified configuration information input by the external; and

adjust the count of piecewise sections of the activation function, and/or adjust the count of sampling points in each of the sections according to the modified configuration information input by the external.

In an example, a definition domain of the activation function may include a plurality of piecewise sections. The data processing device may further include a developing device 100 configured to:

determine an adjusting manner of the configuration information according to the evaluation value of the fitting configuration table; and

automatically adjust the count of piecewise sections of the activation function, and/or adjust the count of sampling points in each of the sections according to the configuration information.

In an example, the fitting configuration table adjusting module 133 is further configured to, if the evaluation value of the fitting configuration table does not meet the preset condition, receive configuration information included in the modified fitting configuration table input by the external, adjust the configuration information of the fitting configuration table according to the configuration information included in the modified fitting configuration table input by the external, so as to obtain a new fitting configuration table until the evaluation value of the new fitting configuration table meets the preset condition.

Alternatively, the evaluation device 200 may further include a hardware interaction unit 134. Specifically, the hardware interaction unit 134 is configured to send the control instruction and the fitting configuration table to an artificial intelligence processor 120. Specifically, the hardware interaction unit 134 is a communication interface of software and hardware. In an example, the hardware interaction unit 134 may include a data copy function provided by a drive program. The data copy function may copy a binary instruction in the developing device 100 to a storage module 123 in the processing device 300. Alternatively, the data processing device may further include a data outputting module configured to output the evaluation value of the fitting configuration table and the process parameters of the evaluation, where the process parameters of the evaluation may include one or more of a computation quantity corresponding to the fitting configuration table, an error of a sampling point, a largest error, and a coordinate of a sampling point corresponding to the largest error.

Alternatively, the data processing device may further include a processing device 300, where the processing device 300 may include an interface module 121, a comparison module 122, and a computation module 124. In an example, the artificial intelligence processor 120 may further include a storage module 123. The developing device 100 may send the fitting configuration table or the control instruction to the storage module 123 in the artificial intelligence processor 120. Furthermore, the interface module 121 may read the fitting configuration table and the control instruction from the storage module 123. The interface module 121 is configured to obtain the fitting configuration table and the input data. Alternatively, the interface module 121 is further configured to obtain the control instruction.

The interface module 121 is configured to obtain the fitting configuration table and the input data of the activation function. Furthermore, the interface module 121 is also configured to obtain the fitting configuration table and the input data sent by the storage module 123. The comparison module 122 is configured to determine a piecewise section in the fitting configuration table corresponding to the input data, and determine corresponding configuration information in the fitting configuration table according to the piecewise section in the fitting configuration table corresponding to the input data. The comparison module 122 may be connected to the computation module 124. The computation module 124 is configured to perform a fitting operation on the input data according to the fitting configuration table to obtain output data of the activation function. Alternatively, the interface module 121 is further configured to send the output data to the external of the artificial intelligence processor 120.

Alternatively, the computation module 124 may include a hardware instruction set obtaining unit and a compiling unit. The hardware instruction set obtaining unit is configured to obtain a hardware instruction set. The compiling unit is configured to generate a control instruction by compiling according to the hardware instruction set and the fitting configuration table.

Alternatively, the device may further include a compiling module 125 and an output data generating module 126. The compiling module 125 is configured to translate the control instruction to a machine instruction. The output data generating module 126 is configured to obtain output data of the activation function according to the fitting configuration table, the input data, and the machine instruction.

A specific description of the data processing device is similar to the description of the data processing method above, and is thus omitted here. Each of the units in the data processing device above may be wholly or partially implemented through software, hardware, and a combination thereof. Each of the units above may be embedded or independently arranged in a processor of a computer equipment in a form of hardware, and may also be stored in a memory of the computer equipment in a form of software, so that the processor may call and perform a corresponding operation of each of the units.

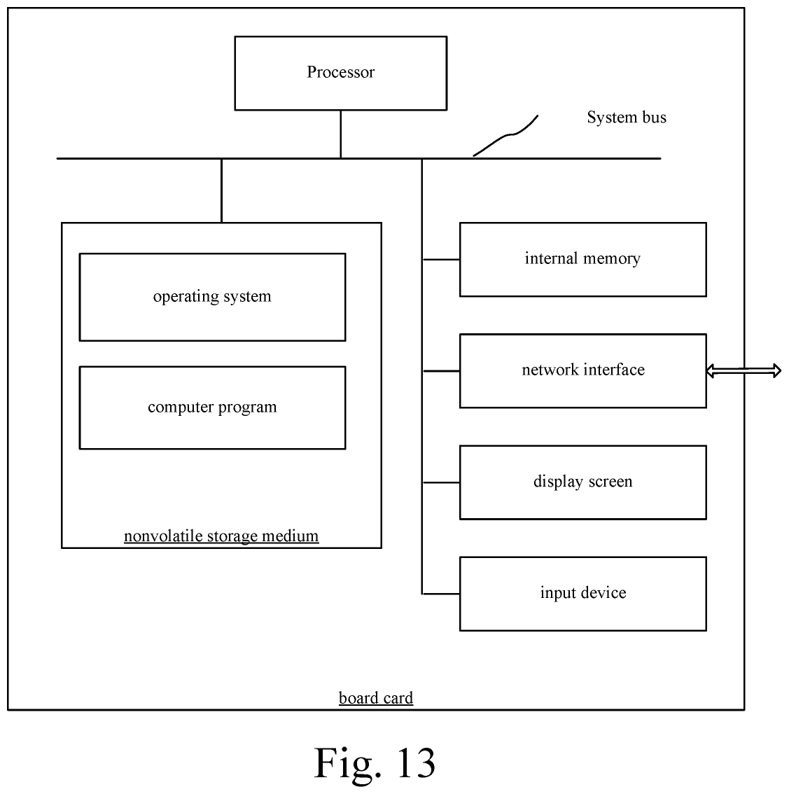

An example of the present disclosure provides a board card, of which an internal structure is shown in FIG. 13. The board card may include an artificial intelligence processor, a memory, a network interface, a display screen, and an input device that are connected by a system bus. The artificial intelligence processor can provide computing and controlling capabilities. The memory of the board card may include a nonvolatile storage medium and an internal memory. An operating system and a computer program may be stored in the nonvolatile storage medium. The internal memory may provide an environment for the running of the operating system and the computer program in the nonvolatile storage medium. The network interface of the board card may be configured to communicate with an external terminal via a network connection. When the computer program is executed by the processor, the computer program may implement the method of any of the examples above. The board card provided by the present example may implement the above-mentioned method examples with similar implementation principles and technical effects, which are thus omitted here.

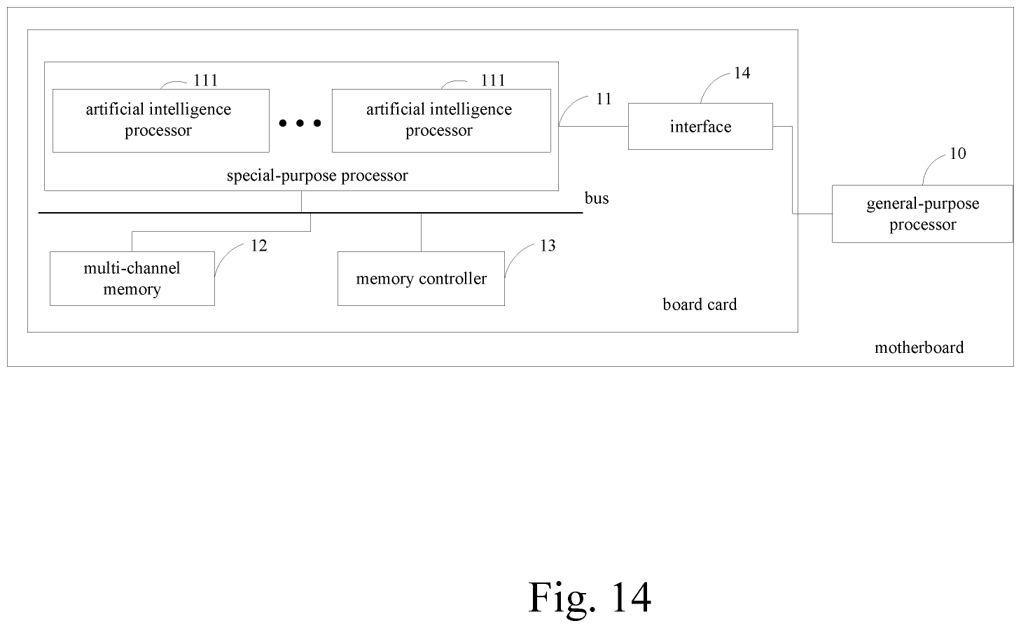

In an example, the present disclosure further provides a motherboard that can be applied to the method of any of the examples above. As shown in FIG. 14, the motherboard may include a general-purpose processor (CPU) 10 and the board card provided in the example above. The board card may include a plurality of artificial intelligence processors 111, where a memory corresponding to the plurality of artificial intelligence processors 111 is a multi-channel memory. A target artificial intelligence processor is configured to receive an artificial intelligence processor computation instruction sent by CPU through a target parallel thread, then use a memory channel corresponding to the target parallel thread to access a physical memory corresponding to the memory channel according to the artificial intelligence processor computation instruction. The target artificial intelligence processor is any of the plurality of artificial intelligence processors, and the target parallel thread is any of a plurality of parallel threads started by the CPU, where at least two threads of the plurality of parallel threads correspond to different memory channels. The motherboard provided by the present example may implement the above-mentioned method examples. Specifically, the general-purpose processor of the motherboard may perform the functions of the developing device and the evaluation device provided by the above-mentioned examples. The board card of the motherboard may perform the function of the processing device. Implementation principles and technical effects of the motherboard are similar to those of the above-mentioned examples, and are thus omitted here.

An example provides an electronic device that can be applied to any method of the examples above. The electronic device may include the motherboard shown in FIG. 14. The motherboard may include CPU and a board card. A processor on the board card may be an artificial intelligence processor. A count of the artificial intelligence processors may be plural. Memories corresponding to the plurality of the artificial intelligence processors may be multi-channel memories. A target artificial intelligence processor is configured to receive an artificial intelligence processor computation instruction sent by CPU through a target parallel thread, then use a memory channel corresponding to the target parallel thread to access a physical memory corresponding to the memory channel according to the artificial intelligence processor computation instruction. The target artificial intelligence processor is any of the plurality of artificial intelligence processors, and the target parallel thread is any of a plurality of parallel threads started by the CPU, where at least two threads of the plurality of parallel threads correspond to different memory channels.

Alternatively, the electronic device may include a data processing device, a robot, a computer, a printer, a scanner, a tablet, a smart terminal, a mobile phone, a traffic recorder, a navigator, a sensor, a webcam, a server, a cloud-based server, a camera, a video camera, a projector, a watch, a headphone, a mobile storage, a wearable device, a vehicle, a household appliance, and/or a medical equipment. The vehicle may include an airplane, a ship, and/or a car. The household electrical appliance may include a television, an air conditioner, a microwave oven, a refrigerator, an electric rice cooker, a humidifier, a washing machine, an electric lamp, a gas cooker, and a range hood. The medical equipment may include a nuclear magnetic resonance spectrometer, a B-ultrasonic scanner, and/or an electrocardiograph.

The electronic device provided by the present example may implement the above-mentioned method examples with similar implementation principles and technical effects, which are thus omitted here.

An example of the present disclosure provides a computer readable storage medium. A computer program may be stored in the computer readable storage medium. The computer program may implement the steps of any of the methods above when the computer program is executed by a processor.

One of ordinary skill in the art can understand that the entire or part of the flow in the methods as stated in the examples can be carried out by instructing related hardware by a computer program which may be stored in a nonvolatile computer readable storage medium. When the program is executed, it may include the flow of each of the method as stated in the examples. Any reference used in the examples provided in the present disclosure to the memory, storage, database, or any other medium may include a nonvolatile and/or volatile memory. The nonvolatile memory may include ROM (Read Only Memory), PROM (Programmable ROM), EPROM (Electrically PROM), EEPROM (Electrically Erasable PROM), or flash memory. The volatile memory may include RAM (Random Access Memory) or external cache memory. By way of illustration, and rather than limitation, RAM may be obtained in various forms, such as SRAM (Static RAM), DRAM (Dynamic RAM), SDRAM (Synchronous DRAM), DDRSDRAM (Double Data Rate SDRAM), ESDRAM (Enhanced SDRAM), SLDRAM (Synchlink DRAM), RDRAM (Rambus Direct RAM), DRDRAM (Direct Rambus Dynamic RAM), and RDRAM (Rambus Dynamic RAM).

The technical features in the above-mentioned examples may be combined randomly. For a brief description, not every possible combination of the technical features in the above-mentioned examples is described. However, combinations of these technical features shall be considered within the range of the description as long as they do not contradict to each other.

The above-mentioned examples are merely some examples of the present disclosure. The disclosure is described in a detailed way. Nonetheless, it should not be considered as limitation on the scope of protection claimed by the present disclosure. It should be indicated that one of ordinary skill in the art may make some variations and improvements within the idea of the disclosure, and these variations and improvements are within the scope of protection claimed by the present disclosure. Therefore, the scope of protection claimed by the present disclosure shall be subject to the attached claims.

1. A data processing method comprising:
obtaining an activation function and a fitting configuration table;
evaluating the fitting configuration table according to the activation function, and generating an evaluation value of the fitting configuration table; and
if the evaluation value of the fitting configuration table does not meet a preset condition, adjusting configuration information to obtain a new fitting configuration table until the evaluation value of the new fitting configuration table meets the preset condition.

2. The method of claim 1, wherein the if the evaluation value of the fitting configuration table does not meet the preset condition, adjusting the configuration information to obtain the new fitting configuration table until the evaluation value of the new fitting configuration table meets the preset condition includes:
obtaining an evaluation value tolerance of the fitting configuration table, and if the evaluation value of the fitting configuration table does not meet the evaluation value tolerance, adjusting the configuration information to obtain the new fitting configuration table until the evaluation value of the new fitting configuration table meets the evaluation value tolerance.

3. The method of claim 2, wherein, the evaluation value tolerance includes a computation quantity tolerance, and the if the evaluation value of the fitting configuration table does not meet the evaluation value tolerance, adjusting the configuration information to obtain the new fitting configuration table until the evaluation value of the new fitting configuration table meets the evaluation value tolerance includes:
obtaining a computation quantity corresponding to the fitting configuration table according to the fitting configuration table, and
if the computation quantity corresponding to the fitting configuration table is greater than the computation quantity tolerance, adjusting the configuration information to obtain the new fitting configuration table until the computation quantity corresponding to the fitting configuration table is less than or equal to the computation quantity tolerance.

4. The method of claim 2, wherein, the evaluation value tolerance of the fitting configuration table further includes an error tolerance, and the if the evaluation value of the fitting configuration table does not meet the preset condition, adjusting the configuration information to obtain the new fitting configuration table until the evaluation value of the new fitting configuration table meets the preset condition further includes:
obtaining sampling points of the activation function,
obtaining values of the activation function corresponding to the respective sampling points and function values corresponding to the fitting configuration table,
obtaining errors of the respective sampling points according to the values of the activation function corresponding to the respective sampling points and the function values corresponding to the fitting configuration table, and
if the error of a sampling point is greater than the error tolerance, adjusting the configuration information to obtain the new fitting configuration table until the error of the sampling point is less than or equal to the error tolerance.

5. The method of claim 4, wherein, the if the error of a sampling point is greater than the error tolerance, adjusting the configuration information to obtain the new fitting configuration table until the error of the sampling point is less than or equal to the error tolerance includes:
comparing the errors of the respective sampling points to obtain a largest error, and
if the largest error is greater than the error tolerance, adjusting the configuration information to obtain the new fitting configuration table until the largest error is less than or equal to the error tolerance.

6. The method of claim 4, wherein, a definition domain of the activation function includes a plurality of piecewise sections, wherein each of the piecewise sections has a corresponding error tolerance, and the if the error of a sampling point is greater than the error tolerance, adjusting the configuration information to obtain a new fitting configuration table until the error of the sampling point is less than or equal to the error tolerance includes:
for each of the piecewise sections, if the error of a sampling point in the piecewise section is greater than the corresponding error tolerance of the piecewise section, marking the piecewise section as a piecewise section to be adjusted, adjusting corresponding configuration information of the piecewise section to be adjusted to obtain the new fitting configuration table of the activation function until the errors of the sampling points of the respective piecewise section are all less than or equal to the error tolerance corresponding to the piecewise section.

7. The method of claim 1, wherein, prior to the obtaining the activation function and the fitting configuration table, the method further includes obtaining the fitting configuration table according to the activation function which further includes:
obtaining a definition domain of the activation function,
determining a count of piecewise sections of the activation function according to the definition domain,
selecting sampling points in the respective sections according to the count of the piecewise sections of the activation function,
computing values of the activation function corresponding to the respective sampling points according to the activation function, and
fitting the activation function according to the sampling points and the function values of the sampling points to obtain the fitting configuration table.

8. The method of claim 7, wherein, the configuration information includes the count of the piecewise sections of the activation function and a count of the sampling points in the respective sections,
and the if the evaluation value of the fitting configuration table does not meet the preset condition, adjusting the configuration information to obtain the new fitting configuration table until the evaluation value of the new fitting configuration table meets the preset condition includes:
if the evaluation value of the fitting configuration table does not meet the preset condition, adjusting the count of the piecewise sections of the activation function, and/or adjusting the count of the sampling points in the respective sections, then performing the step of obtaining the fitting configuration table according to the activation function to obtain the new fitting configuration table until the evaluation value of the new fitting configuration table meets the preset condition.

9. The method of claim 8, wherein, the adjusting the count of the piecewise sections of the activation function, and/or adjusting the count of sampling points in the respective sections includes:
receiving modified configuration information input by the external, and
adjusting the count of the piecewise sections of the activation function, and/or adjusting the count of the sampling points in the respective sections according to the modified configuration information input by the external.

10. The method of claim 8, wherein, the definition domain of the activation function includes a plurality of piecewise sections, and the adjusting the count of the piecewise sections of the activation function, and/or adjusting the count of the sampling points in the respective sections includes:
determining an adjusting manner of the configuration information according to the evaluation value of the fitting configuration table, and
automatically adjusting the count of the piecewise sections of the activation function, and/or adjusting the count of the sampling points in the respective sections according to the adjusting manner of the configuration information.

11. The method of claim 1, wherein, the if the evaluation value of the fitting configuration table does not meet the preset condition, adjusting the configuration information to obtain the new fitting configuration table until the evaluation value of the new fitting configuration table meets the preset condition further includes:
if the evaluation value of the fitting configuration table does not meet the preset condition, receiving configuration information included in a modified fitting configuration table input by the external, and
adjusting the configuration information of the fitting configuration table according to the configuration information included in the modified fitting configuration table input by the external to obtain the new fitting configuration table until the evaluation value of the new fitting configuration table meets the preset condition.

12. The method of claim 1, further comprising:
outputting and displaying the evaluation value of the fitting configuration table and process parameters of the evaluation, wherein the process parameters of the evaluation include one or more of a computation quantity corresponding to the fitting configuration table, an error of a sampling point, a largest error, and a coordinate of a sampling point corresponding to the largest error.

13-28. (canceled)

29. A motherboard comprising a general-purpose processor CPU and an artificial intelligence processor, wherein the general-purpose processor is configured to:
obtain an activation function and a fitting configuration table;
evaluate the fitting configuration table according to the activation function, and generate an evaluation value of the fitting configuration table; and
if the evaluation value of the fitting configuration table does not meet a preset condition, adjust configuration information to obtain a new fitting configuration table until the evaluation value of the new fitting configuration table meets the preset condition.

30. The motherboard of claim 29, wherein if the evaluation value of the fitting configuration table does not meet the preset condition, the general-purpose processor adjusts the configuration information to obtain the new fitting configuration table until the evaluation value of the new fitting configuration table meets the preset condition, wherein the general-purpose processor is further configured to:
obtain an evaluation value tolerance of the fitting configuration table, and
if the evaluation value of the fitting configuration table does not meet the evaluation value tolerance, adjust the configuration information to obtain the new fitting configuration table until the evaluation value of the new fitting configuration table meets the evaluation value tolerance.

31. The motherboard of claim 30, wherein the evaluation value tolerance of the fitting configuration table includes a computation quantity tolerance, and if the evaluation value of the fitting configuration table does not meet the evaluation value tolerance, the general-purpose processor adjusts the configuration information to obtain the new fitting configuration table until the evaluation value of the new fitting configuration table meets the evaluation value tolerance, wherein the general-purpose processor is further configured to:
obtain a computation quantity corresponding to the fitting configuration table according to the fitting configuration table, and
if the computation quantity corresponding to the fitting configuration table is greater than the computation quantity tolerance, adjust the configuration information to obtain the new fitting configuration table until the computation quantity corresponding to the fitting configuration table is less than or equal to the computation quantity tolerance.

32. The motherboard of claim 30, wherein the evaluation value tolerance of the fitting configuration table further includes an error tolerance, and if the evaluation value of the fitting configuration table does not meet the preset condition, the general-purpose processor adjusts the configuration information to obtain the new fitting configuration table until the evaluation value of the new fitting configuration table meets the preset condition, wherein the general-purpose processor is further configured to:
obtain sampling points of the activation function,
obtain values of the activation function corresponding to the respective sampling points and function values corresponding to the fitting configuration table,
obtain errors of the respective sampling points according to the values of the activation function corresponding to the respective sampling points and the function values corresponding to the fitting configuration table, and
if the error of a sampling point is greater than the error tolerance, adjust the configuration information to obtain the new fitting configuration table until the error of the sampling point is less than or equal to the error tolerance.

33. The motherboard of claim 32, wherein if the error of a sampling point is greater than the error tolerance, the general-purpose processor adjusts the configuration information to obtain the new fitting configuration table until the error of the sampling point is less than or equal to the error tolerance, wherein the general-purpose processor is further configured to:
compare the errors of the respective sampling points to obtain a largest error, and
if the largest error is greater than the error tolerance, adjust the configuration information to obtain the new fitting configuration table until the largest error is less than or equal to the error tolerance.

34. The motherboard of claim 32, wherein a definition domain of the activation function includes a plurality of piecewise sections, each piecewise section has a corresponding error tolerance, and if the error of a sampling point is greater than the error tolerance, the general-purpose processor adjusts the configuration information to obtain the new fitting configuration table until the error of the sampling point is less than or equal to the error tolerance, wherein the general-purpose processor is further configured to:
for each of the piecewise sections, if the error of a sampling point in the piecewise section is greater than the corresponding error tolerance of the piecewise section, mark the piecewise section as a piecewise section to be adjusted, adjust corresponding configuration information of the piecewise section to be adjusted to obtain the new fitting configuration table of the activation function until the errors of the sampling points of the piecewise section are all less than or equal to the error tolerance corresponding to the piecewise section.

35. The motherboard of claim 29, wherein before the general-purpose processor obtains the activation function and the fitting configuration table, the general-purpose processor is further configured to:
obtain a definition domain of the activation function,
determine a count of piecewise sections of the activation function according to the definition domain,
select sampling points in the respective sections according to the count of the piecewise sections of the activation function,
compute values of the activation function corresponding to the respective sampling points according to the activation function, and
fit the activation function according to the sampling points and the function values of the sampling points to obtain the fitting configuration table.

36. A computer readable storage medium, wherein the computer readable storage medium stores a computer program, and when a processor executes the computer program, the computer program is configured to:
obtain an activation function and a fitting configuration table;
evaluate the fitting configuration table according to the activation function, and generate an evaluation value of the fitting configuration table; and
if the evaluation value of the fitting configuration table does not meet a preset condition, adjust configuration information to obtain a new fitting configuration table until the evaluation value of the new fitting configuration table meets the preset condition.
